(19) United States
(12) Patent Application Publication
(10) Pub. No.: US 2020/0027093 A1
(43) Pub. Date: Jan. 23, 2020

(54) COMPUTER NETWORK AND DEVICE FOR LEVERAGING RELIABILITY AND TRUST/SOCIAL PROOF

(71) Applicant: ADACTA Investments Ltd., Nicosia (CY)

(72) Inventor: Tomaz VOLK, Ljubljana (SI)

(21) Appl. No.: 16/038,958

(22) Filed: Jul. 18, 2018

(51) Int. Cl. G06Q 30/00; H04L 29/08

(52) U.S. Cl. CPC G06Q 30/012; H04L 67/104; G06Q 30/016

(57) ABSTRACT

Computer, device or peer network, device and method for providing a reliable service. The reliability or trust is leveraged by a guarantee of some other endorsing node/peer, which can be used as a compensation if service and/or replacement service from node/peer is not provided in required quality. Network consists of providing devices/peers, which have a respective trust level and offer a service, and a receiving devices/peers, which demand this service and adapt the demand based on the trust level of the providing device/peer and at least one endorsing device/peer influencing the trust level of the providing device/peer.

### FIELD OF THE INVENTION

Embodiments described herein relate to a computer network, which leverages trust among participating peers and/or devices. One further embodiments relates to providing computational power, resulting in more reliable performance of the network. Another further embodiment relates to using concept of social proof, e.g. within the network.

### BACKGROUND

People (peers) live in a complex world with many interactions among them. When interacting, peers try to or finally do agree on some kind of transaction. Each peer can fulfill its obligations or not and can perform well or poorly. All these interactions are monitored and managed by a network of devices (enhanced computers) which communicate among themselves and share and store information. One device is assigned to each peer. Device networks consist of several devices (nodes), prone to failure and confronted with a plurality and variety of demands. Thus, it is not always reliable that a service is provided properly by such a device or peer associated to its respectable device. Further, devices usually have no deeper insight in the way other devices/peers are working. Faulty behavior may occur, e.g. due to hardware defects, overload, software bugs or risky scheduling policy. Due to these reasons, a device/peer which wants to receive a service from another device/peer does not know, how reliable this service will be. For example, a receiving device/peer who wants to outsource a task needs a service provided by a providing device/peer. It has no clue, which of the available devices/peers would provide the service at best or in an agreed way.

### OBJECT OF THE INVENTION

It is an object of the present invention to disclose a computer network and methods comprising higher reliability when providing/receiving services or doing transactions.

The object is solved by devices interlinked by a computer network and a computer network and methods according to the independent claims.

The present invention provides a computer/device/peer network, comprising a providing device/peer, which has a trust level and is offering a service. A receiving device/peer, which demands this service adapts its demand based on the trust level of the providing device/peer. At least one endorsing device/peer influences the trust level of the providing device.

Preferably, in case of malfunction of the service or poor performance, the endorsing device/peer provides a compensatory service or (final) compensation, e.g. a fee, in case compensatory service is not possible.

Preferably, the compensatory service substitutes the service which malfunctioned.

Preferably, the demand is part of a transaction and is to be agreed on by the providing and/or receiving device/peer, before the transaction takes place.

Preferably, transaction terms are calculated based on the trust level of the providing device/peer and/or the compensatory services of one or more endorsing devices/peers.

Preferably, the trust level is influenced by an endorsing device/peer. This may take the form of a change of the trust level given by an endorsing device/peer and/or the number of endorsing devices/peers. Trust level may also or alternatively be influenced by the compensatory service that an endorsing device/peer promises and/or a history of successful or failed service provisions or transactions.

Preferably, the endorsing device/peer has a benefit level, which is influenced by the providing device/peer and/or receiving device/peer in return for influencing the trust level or promise or provide compensatory service.

Preferably, the trust-, receiver- and/or benefit level are saved in each device/peer itself or are saved in separate trust devices/peers, each one related to each providing or endorsing device/peer or are saved all together in a central server, e.g. written on a blockchain, optionally managed by devices/peers of the claimed type.

Further preferably, trust-, receiver- and/or benefit levels can be saved using a blockchain, centrally or in a distributed way.

Preferably, at least the providing and endorsing devices are personal mobile devices. These can be multipurpose devices.

Further preferably; a penalty is defined; if the transaction does not happen according to the terms, which is granted to a suffering device/peer.

Further preferably, dispute resolving is performed by devices/peers of the network, which do not participate in the transaction, if there is a dispute whether or not a service was provided according to the transaction terms.

The present invention further provides a device, used in a Computer/Device/Peer network, as specified by the invention, working either or in combination as:
a providing device, which has a trust level and is offering a service;
a receiving device/peer; which demands a service from a providing device and adapts its demand based on the trust level of the providing device/peer; or/and
a endorsing device/peer, influencing the trust level of a providing device/peer.

The present invention further provides a method for providing a reliable service within a computer/device/peer network comprising a providing device, which has a trust level and is offering a service. A receiving device/peer, which demands this service adapts its demand based on the trust level of the providing device/peer. At least one endorsing device/peer influences the trust level of the providing device/peer.

The present invention further provides a method for providing computation power within a computer network, comprising a providing computer, which has a trust level and is offering computation power. A receiving computer, which demands this computation power adapts its demand, e.g. price, latency, bandwidth, MIPS, based on the trust level of the providing computer. At least one endorsing computer influences the trust level of the providing computer.

The present invention further provides a method for running a social proof computer network or device, comprising a personal mobile providing device, belonging to a person, which has a trust level and is offering a deal or transaction. A receiving device of a counterpart, which demands this deal or transaction, adapts its demand based on the trust level of the person, who the personal mobile providing device belongs to. At least one endorsing device influences the trust level of the providing device.

The present invention further provides a method for running a social proof computer network or device, comprising an personal pocked sized devices (e.g. mobile smartphone like device) interconnected to exchange data with the purpose to check a person's or peer's trust level. When a person or peer gives a promise or agrees to a transaction, the counterpart can check this person's or peer's trust level, to decide whether to do the transaction or not or to change the conditions/demand and make an amended offer. The at least one endorser is carrying another such a personal device. If the person doing the transaction breaks the promise or does not behave according (willingly, or by accident) to transaction rules, than the at least one endorser is obliged to step in and fulfill that promise or act according to transaction rules. At least one endorser receives benefits for being exposed to the possibility of having to step in.

Preferably, the trust level is influenced by a change of the trust level given by an endorser and/or the number of endorsers and/or the compensatory service, i.e. the height of an obligation, an endorser promises and/or a history of successful or failed transactions.

Preferably, the devices calculate a single indicator measuring the value of trust of each individual device.

### DESCRIPTION OF THE DRAWINGS

Preferred embodiments of the present invention will now be described with reference to the drawings, in which:

FIG. 1 illustrates a computer network in accordance with the present invention.

### DESCRIPTION OF THE COMPUTER NETWORK FOR LEVERAGING TRUST

The term “peer” within this description may have different meanings according to the concerning embodiment. A person might be named as a peer. Simultaneously, the personal device this person carries, might be named as “peer” as well. From a technical point of view, interactions are done by the peer-device, either automated or by user-interaction. Peer-devices may be joined in a (distributed) peer-to-peer network, i.e. an egalitarian social network. Alternatively, a client-server based network is applicable, too, whereas the peer-devices function as clients and the server is a central instance. In consequence, the network contains personal devices/computers (peers), which may be associated with persons. Personal devices (peer-devices) are computers.

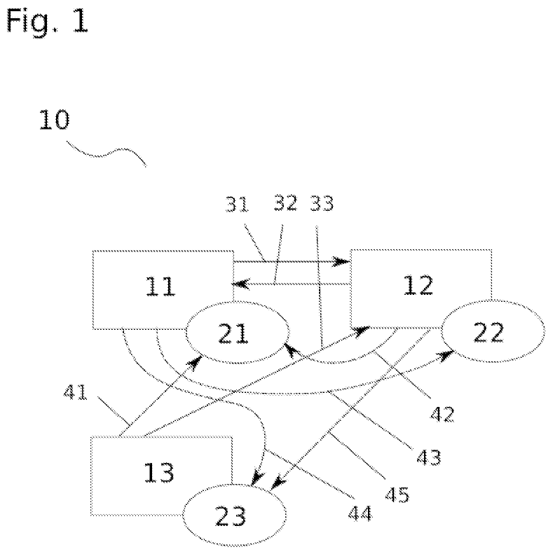

FIG. 1 illustrates a computer/device/peer network 10 with the interacting participants for offering a service 31, a resource 31 or doing a transaction 31, 32 based on a trust level 21. A providing device/peer 11 interacts with a receiving device/peer 12, e.g. by providing or offering a service 31. The receiving device/peer 12 interacts with the providing device/peer 11 by demanding 32 or accepting a service 31 or taking part in a transaction 31, 32.

Different modes of interactions are possible, just as examples:

1. A service 31 is offered by the providing device/peer 11 and is accepted or declined via a message 32 by the receiving device/peer.

2. A request/demand 32 is sent from a receiving device/peer 12 to ask for a service from a providing device/peer 11. If the providing device/peer 11 is able or willing to provide the service 31, it is provided to the receiving device/peer 12.

3. Two devices/peers, a providing device/peer 11 and a receiving device/peer 12 negotiate a transaction based on different parameters. Amongst them is at least the trust level 21 of the providing device/peer 11. This negotiation may continue iteratively until terms are mutually agreed upon. Then a transaction takes place, involving a resource/service/message 31 sent and another one received 32 by the providing device/peer 11. According to the agreement of the negotiation, sending 31 and receiving 32 may not be performed simultaneously, but with time difference.

These interactions are done by taking a trust level 21 of the providing device/peer 11 into account. They optionally also take a receiver level 22 of a receiving device/peer 12 into account. These levels are influencing if and how a service or transaction is provided or accomplished.

For not performing and keeping to the negotiation terms (promise), a penalty fee can be defined. In case of not being able to provide service 31 or if the service is not provided according to agreed quality, a penalty is paid to the suffering peer to compensate. Penalty can also be paid partially by the breaching device/peer 11 and partly by an endorser 13, to support positive behavior by peer pressure, because they are penalized or they have to provide substitute service or part of the service. Penalty might comprise money, resources, trust level.

In case there is a dispute among providing device/peer 11 and receiving device/peer 12 whether the service was provided adequately or not, the network of devices peers 10 steps in and resolves dispute either in favor of the providing device/peer 11 or the receiving device/peer 12. The resolution of the network may be final and may be based on a voting principle. The majority of votes prevails and may be issued by participants of the network. Optionally, there may only be a subset of devices/peers involved in voting.

### EXAMPLES

1. A receiving device 12 may only be willing to accept a service 31 from a providing device 11 which has at least a certain trust level 21, This trust level 21 indicates a reliability estimation of the provision of a service 31, i.e. likelihood that the providing device 11 will provide the service 31 properly.

2. The receiver level 22 might help a providing device 11 to estimate, if it is worth to provide the service 31 to the receiving device 12. A low receiver level 22 might indicate that a service 31 provided to the receiving device 12 is diminished, wasted or misused. Besides that, it may indicate that a counteraction 32 from the receiving device 12 was not accomplished properly or according to the rules.

The trust level 21 may be influenced 41 by an endorsing device 13. In particular, the endorsing device may increase 41 the trust level 21, if the endorsing device 31 trusts the providing device 11.

Therefore, peers may be requested to function as an endorsing device 13 by several instances, e.g.:
the providing device 11 knows one or several possible endorsing devices 13, the providing device may choose one or a plurality of them, which are willing and/or capable to endorse, or whom the providing device 11 trusts (the most);
the receiving device 12 knows one or several possible endorsing devices 13, the providing device may choose one or a plurality of them, which are willing and/or capable to endorse, or whom the receiving device 12 trusts (the most);
the providing device 11 knows one or several possible endorsing devices 13, the receiving device 12 may choose one or a plurality of them, which are willing and/or capable to endorse, or whom the receiving device 12 trusts (the most);
the receiving device 12 knows one or several possible endorsing devices 13, the providing device 11 may choose one or a plurality of them, which are willing and/or capable to endorse, or whom the providing device 11 trusts (the most);
a request for endorsement is broadcasted (general request) and peers willing and/or capable to negotiate or take the risk of endorsing are answering.

Alternatively, the endorsing device 13 can measure the likelihood of the proper provision of a service 31 by the providing device 11, to estimate the level of trust 41 it is willing to assign/add to the providing device 11.

For example, the endorsing device 13 may measure historical data how reliable the service provision 31 of the providing device 11 was in the past. This measurement might include service provisions, when the endorsing device 13 itself was a receiving device in the past and dealing with the providing device 11. It also might include service provisions with any receiving devices 12, if such data is made available to the endorsing device 13 measuring the trust.

Further alternatively, an endorsing device 13 might add trust to a providing device 11 because it shares something in common, e.g. the same manufacturer, in case this is a feature deemed to increase reliability.

The trust level 21 may also be influenced by a plurality (not depicted) of endorsing devices 13. The more endorsing devices 13 add trust 41 for a providing device 11, the higher the trust level 21 might get.

The receiving device might also influence 42 the trust level 21 after or while a service provision 31 or transaction 31, 32 takes place. If the interaction worked out well, the level might be increased, otherwise it might be decreased. The magnitude of the increase/decrease may be based on the severity of a failure or the quality of service provisioning. In return, the providing device 11 might influence 43 the receiver level 22 based on the outcome of the finished or ongoing transaction 31, 32.

Endorsing devices 13 who influence 41 the trust level 21 by increasing it, may provide a compensatory service 33 in case the service provision 31 fails or does not adhere to predefined rules. Alternatively, endorsing devices 13 may only influence the trust level 21, if they (are willing to) provide a compensatory service. This assures further the reliability of the service 31. In case the providing device 11 is not able to provide the service 31 as agreed, the compensatory service 33 might work as a fall-back system. The compensatory service 33 may either fully substitute the service 31 which the providing device 11 was supposed to provide or compensate just partly or by reorganizing to help fulfill the demand of the receiving device 12.

Endorsing devices 13 may be called to set/increase a trust level 21 and/or to promise to provide a compensatory service 33 in case. This may happen if the providing device 11 and receiving device 12 are negotiating a service provision 31 or transaction 31, 32 and may be requested by either the providing device 11 or the receiving device 12 or both.

Beyond that, endorsing devices might gain a benefit level 23 for influencing 41 the trust level 21 or the promise to provide a compensatory service 33 or the executed provision of a compensatory service 33. The providing device 11 may influence 44 the benefit level 23 in reverse for giving trust 41. Alternatively or additionally, the receiving device might influence 45 the benefit level 23, e.g. for providing a promise or executing a compensatory service 33. Also, the benefit level 23 might be decreased, if the service provision 31 or the compensatory service 33 fails.

Trust level 21, receiver level 22 and benefit level 23 may consist of just a single value (each), e.g., but not limited to, a value range 0 to 10, whereas 0 means no trust/receivings/benefits at all and 10 means the highest level of trust/receiving s/benefits.

These three levels may also be combined to just one, e.g., in a way that each device (providing 11, receiving 12, endorsing 13) only has one trust value. So a receiving value 22 would work in a trust value 21 in a future interaction, where the receiving device 12 will change its role to the role of a providing device 11. Accordingly, a benefit value 23 might work as a trust level in a future interaction, where the endorsing device 13 will change its role to the role of a providing device 11.

These three levels 21, 22, 23 may be stored at different places, e.g.:

1. Each device 11, 12, 13 stores its own level 21, 22, 23. This is straightforward, as every device will usually want to have its level value available to be able to take part in interactions. On the other hand, the device itself may fraudulently improve its value. Measures could be taken by using secured or signed influences from other participating devices or blockchain technology.

2. Each device 11, 12, 13 has a related single separate device, which takes care of storing the level 21, 22, 23 and handling influences on this level. These devices may be secured, e.g., by hardware measures, as then the related device 11, 12, 13 to which the trust value belongs cannot not alter its level.

3. The levels may be stored centrally, i.e. on a single instance in the network, e.g. on a trust server. In this embodiment, the peers may be clients of a client-server network, the server being the trust server.

3a. Persons or peers have an account on the central instance, where the trust levels are stored. Thus, neither separate devices are needed, nor are the personal devices 11, 12, 13 able to alter their related levels 21, 22, 23, e.g. by fraudulent software on the personal device. Theoretically, no personal devices are necessary in this embodiment, and persons/peers could just log in to their account.

3b. Alternatively, the peers may transmit the trust level amongst themselves, whereas the central instance just verifies if the transmitted levels are correct to prevent fraudulent alterations.

Overall, the advantage of the invention is to create a trust network, where reliable interactions can be secured, or at least the reliability of the interactions is increased compared to networks without such a trust related system. This in particular helps to deal more reliably with providing devices 11 which are not well-known by a receiving device 12. The same advantage applies vice versa to a providing device 11 which may thus agree on providing a service 31 to a receiving device 12 while decreasing the likelihood that the effort for the service 31 is diminished or wasted.

Additionally, risk takers may be rewarded. The endorsers 13 work as risk takers as they might have to provide compensatory service 33 without reward in case the service provision 31 fails. A proven risk taker may be considered to provide reliable service on an above-average level once they become a providing device.

By introducing such a self-regulating system, the motivation of all devices/peers would be to perform well or they will be banned out of a network and no other node/peer will want to do transactions with them. Performing as advertised or agreed upon would become a favorable strategy because any mal-advertising or non-compliance would be penalized by the network or its peers.

In case, if even a replacement transaction fails, the endorser is obliged to pay, e.g., a penalty fee. Using such a network, a person/peer requesting a transaction, has an upfront guarantee or higher likelihood that the transaction will be duly executed either by requesting peer or the peer's endorser. Otherwise, the requesting person/peer will get a compensation from the endorser. Because all nodes will try to avoid doing replacement transactions or paying penalties, the network possesses a self-regulating mechanism, which constantly improves quality of service of the network.

Description of the Example of Providing Computing Power

A first exemplary embodiment relates to providing computing power. The providing device 11 is a computer, which provides computing capacity/power as a service 31 for the receiving device 12, which is also a computer. Thus, the receiving computer 12 is able to outsource a task by using a computing power 31 of another computer 11. Besides outsourcing, another use case is network computing to gain more computing capacity than only one device would be able to provide. A further use case is that the receiving computer outsources its tasks to other computers to be able to go to sleep mode to save energy.

For reasons of load balancing and reliable timelines to finish tasks/calculations, the reliability of the participant(s) 11 providing calculation power 31 should be known. A deterministic forecast of the available computation power 31 instead is often not possible, as providing computers may have other unpredictable tasks to do, which might affect the reliability of the provision of the computing power.

In another use case, both computers might negotiate that the providing computer 11 provides computing power 31 at one time, and the receiving computer 12 provides a second computing power 32 at another time. This might, e.g., allow one of the two computers to be put into sleep mode, while the other is providing the computing power 31, 32.

Other computers in the network 10 might function as endorsing devices 13. These endorsing computers 13 give trust 21 to the providing computer 11. If the provision of computing power 31 fails, then the endorsing computer 13 might take over and provide compensatory computation power 33 instead.

Computers built by the same manufacturer or running the same software or the software of the same manufacturer may increase the trust level amongst each other, because one such device knows the way the other device works and thus is able to more precisely estimate the reliability of the provision of computation power.

Further, the detailed teaching as described for FIG. 1 applies to this first exemplary embodiment.

Description of the Example of a Social Proof Network Leveraging Trust

A second exemplary embodiment relates to a social proof computer network 10 or device for leveraging trust. Thereby, trust (level) 21 is related to a peer/person and a peer/person's behavior. The person carries a personal device 11, which may store the trust level 21 or at least interacts with a device, which stores the trust level of this peer/person. Thus, the term “trust level of the person” and “trust level of the device” technically means the same. The person may be willing to offer a deal or transaction with a receiving person, who also has a personal device 12 and a receiving or trust level 22 related. Friends (or other people knowing the person) of the person might work as endorsers, also having their own personal devices 13, which they use to influence the trust level 21 of the person. Simultaneously, the endorser may agree to provide a compensatory service 33 by using his endorsing device 13.

All transactions can be made safer. The network of devices keeps track for each peer how many promises were kept/broken. The motivation of each participant is not to break the promise (transaction terms), because the trust rating will go down and they might have difficulties in future to find peers to do transactions with or the price of the service will go up accordingly.

As an example: Financial transactions can be made safer as well. Such a deal might be a deal for a loan 32, where the interest rate 31 depends on the trust level 21, which relates to the likelihood that the person 11 will pay back the debt in time. A high trust level leads to low interest, a low trust level 21 leads to higher interest or refusal of the deal/transaction 31, 32, In case an endorser promises to pay the debt in case person 11 defaults, the trust level may be increased and/or the interest rate may be lowered. In this financial example, the service offered is paying the interests 31, while providing the loan is the interaction 32 of the counterpart 12.

The network of devices measures peer diligence and responsibility, which also works in a case of dealing with randomness. With a diligent and responsible peer/person, there is a lower probability of an unwanted outcome. For example, if a transaction is related to a car rental and the renter (peer) is considered diligent and responsible and this can be confirmed by the network of endorsers, such a person might pay lower prices than an irresponsible person might need to pay. In general, the probability that the car will break or will be involved in incident is lower.

In other words and in a more detailed embodiment:

Personal pocket-sized devices 11 are interconnected 10 to exchange data which is used to check a person's trust level 21. When a person 21 gives a promise or agrees to a transaction, the counterpart 22 can check this person's trust level 21, to decide whether to do the transaction 31, 32 or not or to change the conditions/parameters/demand and make an amended offer 32. Each person can have one or many endorsers carrying the same devices 23. Each person can have many endorsers as well, and these endorsers can further have endorsers. If the person doing transaction 31 breaks the promise or does not behave according (willingly, or by accident) to transaction rules, then endorsers are obliged to step in 33 and fulfill that promise or act according to transaction rules. These endorsers 23 receive 44, 45 benefits 23 for being exposed to having to step in 33. The counterpart 22 can therefore more reliably trust the person 21, because he can check the device having the trust level 21 and see what are the measures and promised acts 33 of endorsers 23 in case the person 11 does not fulfill the promise or play according to the defined rules. Who and what has to be done in case of breaching is determined by devices 11, 12, 13, which are interconnected. In case a replacement service cannot be provided, a penalty fee is paid partially by the breaching peer and partially by endorsers to support positive behavior by peer pressure. The devices calculate a single indicator measuring a value of trust 21, 22, 23 of each individual device 11, 12, 13 as well. More endorsers 23 means higher trust level. A history of not breaching the transaction rules also means higher trust 21 than a history of breached rules. Higher obligations of stepping in 33 in case of breaching also mean higher trust level 21, 23. Such a network of devices 10 would improve people's behavior, because by not playing according to transaction rules, they would harm in a certain way their endorsers, e.g., friends or family members and this is something the person usually does not want to happen. The device can in the future be extended with other functionalities to add existing functionalities we use today on a mobile phone so that participants will not have to carry a mobile phone together with this social proof device. Alternatively, the feature can be implemented by means of software and run on participants' personal pocket size devices which can in the future be extended with phone functionalities. Further alternatively, a central instance may administer the trust level 21 and provide information about the person or participants.

Further, the detailed teaching as described for FIG. 1 applies for this second exemplary embodiment.

### LIST OF REFERENCE SIGNS

10 Computer Network
11 Providing device
12 Receiving device
13 Endorsing device
21 Trust level/device
22 Receiver level/device
23 Benefit level/device
31 Interaction from the providing device/service
32 Interaction from the receiving device
33 Compensatory service
41 Influence on trust level by endorsing device
42 Influence on trust level by receiving device
43 Influence on receiver level by providing device
44 Influence on benefit level by providing device
45 Influence on benefit level by receiving device

1. Computer Device/Peer network, comprising:
a providing device/peer, which has a trust level and is offering a service;
a receiving device/peer, which demands this service and adapts its demand based on the trust level of the providing device/peer; and
at least one endorsing device/peer, influencing the trust level of the providing device/peer.

2. Computer Device/Peer network according to claim 1, wherein,
in case of malfunction or poor performance of the service, the at least one endorsing device/peer provides a compensatory service or compensation.

3. Computer/Device/Peer network according to claim 2, wherein
the compensatory service substitutes the service which malfunctioned.

4. Computer Device/Peer network according to claim 1, wherein
the demand is part of a transaction and is to be agreed on by the providing and/or receiving device/peer before the transaction takes place.

5. Computer/Device/Peer network according to claim 4, wherein
transaction terms are calculated based on the trust level of the providing device/peer and/or compensatory services of one or more endorsing devices/peers of the at least one endorsing device/peer.

6. Computer/Device/Peer network according to claim 1, wherein
the trust level is influenced by at least one of:
a change of the trust level given by an endorsing device/peer of the at least one endorsing device/peer;
a number of the at least one endorsing device/peer;
the compensatory service, an endorsing device/peer of the at least one endorsing device peer promises; or
a history of successful or failed service provisions or transactions.

7. Computer/Device/Peer network according to claim 1, wherein
the at least one endorsing device/peer has a benefit level, which is influenced by the providing device/peer and/or receiving device/peer in return for influencing the trust level or promise or provide compensatory service.

8. Computer/Device/Peer network according to claim 1, wherein
the trust-, receiver- and/or benefit level are either saved in:
each device/peer itself;
separate trust devices/peers, each one related to a respective providing or endorsing device/peer; or
all together in a central server.

9. Computer/Device/Peer network according to claim 1, wherein the trust-, receiver- and/or benefit level are written on a blockchain.

10. Computer/Device/Peer network according to claim 1, wherein
at least the providing and endorsing devices/peers are personal mobile devices.

11. Device, used in a Computer/Device/Peer network as specified in claim 1, working either or in combination as:
the providing device, which has a trust level and is offering a service to one or more other devices in the network;
the receiving device/peer, which demands a service from a providing device in the network and adapts its demand based on the trust level of the providing device/peer; or/and
an endorsing device/peer, of the at least one endorsing device/peer, influencing the trust level of a providing device/peer in the network.

12. Method for providing a reliable service within a computer/device/peer network, comprising:
offering a service by a providing device or peer, which has a trust level;
requesting this service by a receiving device or peer, which adapts its demand based on the trust level of the providing device; and
adapting the trust level of the providing device by an endorsing device or peer.

13. Method for providing computation power within a computer/device network, comprising:
offering computation power by a providing device, which has a trust level;
requesting computation power by a receiving device which adapts its demand based on the trust level of the providing device; and
adapting the trust level of the providing device by at least an endorsing/device.

14. Method for providing computation power within a computer/device network, according to claim 13, wherein the demand corresponds to one or more of the group consisting of: price, latency, bandwidth, and MIPS.

15. Method for running a social proof computer network or device, comprising:
offering a deal or transaction by a personal mobile providing device, belonging to a person or peer, who has a trust level;
requesting the deal or transaction by a receiving device of a counterpart, which adapts its demand based on the trust level of the person/peer to whom the personal mobile providing device belongs; and
adapting the trust level of the providing device by at least one endorsing device.

16. Method for running a social proof computer network or device, comprising:
Using, by a first person/peer, a first personal mobile phone sized device, interconnected with other devices, to exchange data to check a second person's/peer's trust level;
checking the first person's trust level, by a counterpart device of the second person/peer, when the first person/peer gives a promise or agrees to a transaction, to enable the second person/peer to decide whether to do the transaction or not or to change conditions/demands related to the transaction and make an amended offer;
endorsing performance of the promise or transaction by at least one third person/peer associated with a third personal device;
fulfilling the promise or act according to transaction rules by the at least one third person/peer if the first person/peer breaks the promise or does not behave according to one or more transaction rules;
wherein the at least one third person/peer receives at least one benefit for being exposed to the possibility of having to fulfill the promise or act according to the transaction.

17. Method for running a social proof computer network or device, according to claim 16, further comprising:
adapting a trust level or a person/peer based on at least one of:
a change in a trust level given by an endorser to the person/peer;
a number of endorsers of the person/peer;
a compensatory service, corresponding to a degree of an obligation, an endorser promises regarding the person/peer; or
a history of successful or failed transactions of the person/peer.

18. Method for running a social proof computer network or device, according to claim 15, further comprising calculating, by the devices, single respective indicators measuring respective values of trust of respective individual devices.

19. Method for running a social proof computer network or device, according to claim 16, further comprising calculating, by the devices, single respective indicators measuring respective values of trust of respective individual devices.
